(19) United States
(12) Patent Application Publication
(10) Pub. No.: US 2024/0148162 A1
(43) Pub. Date: May 9, 2024

(54) Convertible Child Safety Seat Carrier

(71) Applicants: Chang CHEN TAI, Puzih City (TW); Yu YOUN-FU, Puzih City (TW)

(72) Inventors: Chang CHEN TAI, Puzih City (TW); Yu YOUN-FU, Puzih City (TW)

(21) Appl. No.: 18/502,443

(22) Filed: Nov. 6, 2023

Related U.S. Application Data
(60) Provisional application No. 63/382,909, filed on Nov. 9, 2022.

(51) Int. Cl. A47D 11/00

(52) U.S. Cl. CPC A47D 11/00; B62B 5/082

(57) ABSTRACT

A dual-axis swivel bracket for a deck railing section is disclosed. The bracket is simultaneously adjustable along a first axis and a perpendicular second axis. When one end of the bracket is attached to a post and the other is attached to a rail, the position of the rail may be moved through a wide range of motion to allow for a wide range of installation designs.

### FIELD OF THE INVENTION

The subject matter of this application pertains to child safety seats. More specifically, it pertains to child safety seat carriers such as carts, wagons, or strollers. Even more particularly, the subject matter of this application pertains to carriers for child safety car seats such as strollers, wagons, and carts in which the child safety seat attachment point is convertible for uses other than, and in addition to, attaching a child safety seat.

### BACKGROUND OF THE INVENTION

Since cars first became common, the fortunate (or unfortunate) among the population have had to take their small children on car trips. Although lap belts were known and used in horse-drawn carriages predating automobiles, their adoption in automobiles is storied and beyond the needs of this specification. Suffice it to say that the first car seats for children were probably their mother's lap.

Early child car seats were likely intended to boost the child so they could enjoy the view. Of course, this was when cigarettes were considered healthy, and Merck made cocaine. People think differently about many things now, and modern child car seats are designed to prevent injury in a crash and are less concerned with the view.

Most modern child car seat assemblies, at least for infants, comprise a base and a seat. The base is installed in the car and secured into place, so the base is essentially stationary in the vehicle. The seat itself is then reversibly connected to the base. This allows a caregiver to install a base once and then quickly and easily attach a seat, rather than having to secure the seat in position every time the child is placed in the car.

In addition, this two-component design lets a caregiver quickly move the child seat from a car to a specially adapted stroller, wagon, or other such transport.

Eventually, to the chagrin of parents everywhere, babies grow and eventually don't need to be in a safety car seat, especially not one attached to a wagon. It would be preferable if such a transport had a usable life beyond the child's infancy. An even more preferable design would increase the storage capacity of such a transport when a safety seat is no longer required.

### SUMMARY

The subject matter of this application pertains to methods and devices for transporting children in safety car seats and goods. We disclose a transport that can be used to hold a safety car seat via an adapter that can be configured to hold other goods when the safety seat is not needed.

### BRIEF DESCRIPTION OF DRAWINGS

FIG. 1 shows the first, second, and third members of the disclosed car seat adapter with the third member in the first position of the rotational mount.

FIG. 2 shows the first, second, and third members of the disclosed car seat adapter with the third member in the second position of the rotational mount.

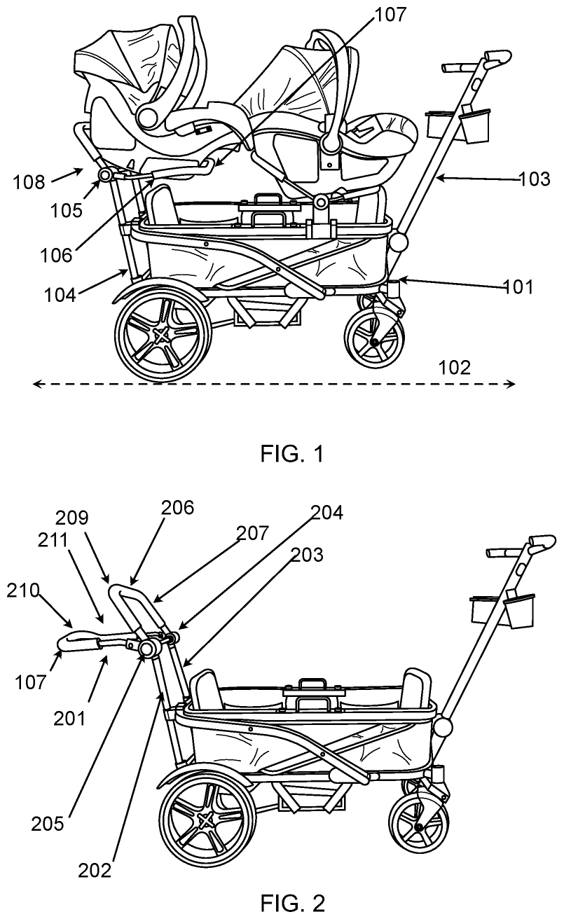

### DETAILED DESCRIPTION OF THE INVENTION

Each reference number consists of three digits. The first digit corresponds to the figure number in which the referenced item is first or best shown. Reference numbers are not necessarily discussed in the order of their appearance in the figures. Drawings are not necessarily to scale.

The following description and referenced drawings illustrate embodiments of the application's subject matter. They are not intended to limit the scope. Those familiar with the art will recognize that other embodiments of the disclosed method are possible. One should consider all such alternative embodiments within the application's disclosure.

Certain word choices are made for simplicity and to aid the reader's understanding by placing the subject matter of this application in context. These word choices should not be interpreted to narrow the scope of the claims, which should be given their broadest possible meaning in the light of the disclosure. For example, as used in this application: “child safety car seat” and “car seat” may include child safety seats, child safety car seat bases, and any other similar vehicle seat adjunct. Further, “car” encompasses any vehicle, and “wagon” encompasses any non-automotive used to move a baby, such as a stroller, jogger, cart, wagon, or wheelbarrow. A tube may be a structure of any type suitable for the use disclosed herein. Have or has means comprises.

A Convertible child safety seat carrier comprises a chassis (101) having a longitudinal axis (102), a handle (103) and a multi-purpose support (201).

The multipurpose support comprises a first tube (202) and a second tube (203), a crossbar (204), and a rotational mount (205). Each said tube has a proximal end (e.g., 104) and a distal end (e.g., 105). This distal end of each tube is connected to the chassis and the proximal end of each tube is connected to the rotational mount. The multipurpose support further comprises a u-shaped stationary support (206) having a first arm with a terminus (207), a second arm with a terminus (208) and a crossbar (xxx) bridging the two arms. In most useful embodiments, the stationary support is separable from the rest of the multipurpose support.

The multipurpose support further has a movable mounting structure having a first arm with a terminus (106), a second arm with a terminus (210), and a crossbar connecting the two arms. In the most useful embodiments, the mounting structure further comprises a bend (107).

The terminus of the first arm and the terminus of the second arm of the multipurpose support are adapted to connect to the rotational mount. In the most useful embodiments, the rotational mount is movable between a first position (108) and a second position (211). Said movable mounting structure being largely parallel to the longitudinal axis of the chassis in either said position, with the crossbar being proximal from the handle of the cart when in the first position and distal to the handle of the cart when in the second position.

In most useful embodiments, the car seat adapter further comprises one or more straps adapted to secure a car seat to the car seat adapter.

In use, a car seat may be placed on to the crossbars of the movable mounting structure and of the stationary support of the multipurpose support when the rotational mount is in the first position. The car seat is then reversibly secured in place with said straps. In some embodiments, the car seat adapter comprises one or more attachment points by which a hook or clamp on the car seat may attach.

When used without the need for a car seat, the rotational mount may be rotated into the second position and the movable mounting structure may be used as a form of bracket and used to hold bags or beach chairs or other suitable items. When in the second position of the rotational mount, the bend of the third member is angled upwards to prevent items hung from the movable mounting structure from falling.

1. A convertible child safety seat carrier comprising a chassis having a longitudinal axis, a handle and a multi-purpose support;
said multi-purpose support comprising a first tube, a second tube, a crossbar, a rotational mount, a stationary support, and a movable support;
said stationary support being a U-shaped structure having a first arm with a terminus, a second arm with a terminus, and a crossbar;
said movable support being a U-shaped structure having a first arm with a terminus, a second arm with a terminus, a longitudinal axis, and a crossbar;
each said terminus of the movable support being connected to the rotational mount such that the movable support is capable of pivoting about said rotational mount by approximately 180°.

2. The convertible child safety seat carrier of claim 1 in which the movable support may be fixed in one for two positions:
the first position being approximately parallel to the longitudinal axis of the chassis when the crossbar of the movable support is proximal to the handle, and
the second position being approximately parallel to the longitudinal axis of the chassis when the crossbar of the movable support is distal to the handle.

3. The convertible child safety seat carrier of claim 2 in which the crossbar of the movable support deflects from the longitudinal axis of the movable support.

4. The convertible child safety seat carrier of claim 3 in which upward when the movable support is in the second position and downward when the movable support is in the first position.

5. The convertible child safety seat carrier of claim 2 in which the multi-purpose support is adapted to reversibly attach to a child safety car seat when the movable support is in the first position.

6. The convertible child safety seat carrier of claim 5 in which said child safety car seat comprises a first connection point capable of being reversibly connected to the crossbar of the stationary support, and a second connection point capable of being reversibly connected to the crossbar of the movable support.
